(19) United States
(12) Patent Application Publication
(10) Pub. No.: US 2026/0091878 A1
(43) Pub. Date: Apr. 2, 2026

(54) AIRCRAFT PROPULSION ASSEMBLY COMPRISING A SUPPORTING STRUCTURE CONNECTING AN ENGINE ASSEMBLY AND A PRIMARY STRUCTURE OF A PYLON AND SUPPORTING AT LEAST ONE ACCESSORY

(71) Applicant: Airbus Operations SAS, TOULOUSE (FR)

(72) Inventors: Rémi LANSIAUX, TOULOUSE (FR); Nicolas CHARTON, TOULOUSE (FR); Jean-Baptiste VIGNES, TOULOUSE (FR); Julien VINOT, TOULOUSE (FR); Xavier CARCENAC, TOULOUSE (FR); Mohammed-Amine BENNAIEM, TOULOUSE (FR)

(21) Appl. No.: 19/342,918

(22) Filed: Sep. 29, 2025

(30) Foreign Application Priority Data
Sep. 30, 2024 (FR) FR2410480

(51) Int. Cl. B64D 27/40

(52) U.S. Cl. CPC B64D 27/402

(57) ABSTRACT

An aircraft propulsion assembly including: an engine assembly that has front and rear parts offset along a longitudinal axis, a primary structure of the pylon, at least one supporting structure that extends along an axis parallel to the longitudinal axis, connected to the front part of the engine assembly, supporting at least one accessory, an engine-attachment system that includes: at least one front attachment directly connecting the engine assembly and the primary structure, at least one rear attachment offset toward the rear relative to the front attachment connecting the primary structure 42 and the supporting structure.

### CROSS-REFERENCES TO RELATED APPLICATIONS

This application claims the benefit of French Patent Application Number FR2410480 filed on Sep. 30, 2024, the entire disclosure of which is incorporated herein by way of reference.

### FIELD OF THE INVENTION

The present application relates to an aircraft propulsion assembly comprising a supporting structure connecting an engine assembly and a primary structure of a pylon and supporting at least one accessory and to an aircraft including at least one such propulsion assembly.

### BACKGROUND OF THE INVENTION

In a configuration that can be seen in FIGS. 1 to 3 an aircraft 10 includes a plurality of propulsion assemblies 12 that are positioned under the wings 14 of the aircraft 10.

A propulsion assembly 12 includes an engine assembly 16, a nacelle (not represented in FIGS. 2 and 3) positioned around the engine assembly 16 and a pylon 18 connecting the engine assembly 16 to the rest of aircraft 10, in particular to the wings 14.

In the remainder of the description a longitudinal direction X is parallel to the rotation axis A16 of the engine assembly 16. A transverse plane is a plane perpendicular to the rotation axis A16 of the engine assembly 16. A longitudinal plane is a plane passing through the rotation axis A16 of the engine assembly 16. A transverse and horizontal direction Y is a horizontal direction perpendicular to the rotation axis A16 of the engine assembly 16. A transverse and vertical direction Z is a vertical direction perpendicular to the rotation axis A16 of the engine assembly 16. A median vertical plane PMV is a vertical plane containing the rotation axis A16 of the engine assembly 16. The terms front and rear refer to the direction of flow of the flow of air in the engine assembly 16, flowing from the front to the rear.

The engine assembly 16 includes a fan 20 that includes a fan fairing 20.1 and an engine core 22 that has a front part 22.1 positioned inside the fan 20, a central part 22.2 and a rear part 22.3 incorporating in particular a jet pipe. In one configuration the central part 22.2 has a cross section less than that of the front and rear parts 22.1, 22.3. The engine core 22 has an exterior envelope called the engine assembly fairing F22.

The pylon 18 includes a primary structure 24 in the form of a box that is connected to the wings 14 by a wing-attachment system 26 and to the engine assembly 16 by an engine-attachment system 28. This primary structure 24 has a front end 24.1, a median part 24.2 and a rear end 24.3.

In a first embodiment that can be seen in FIG. 2 the engine-attachment system 28 includes a front attachment 28.1 connecting the front end 24.1 of the primary structure 24 and the front and/or central part 22.1, 22.2 of the engine core 22, a rear attachment 28.2 connecting the rear end 24.3 and/or the median part 24.2 of the primary structure 24 and the rear part 22.3 of the engine core 22, and two links 28.3 positioned symmetrically with respect to the median vertical plane of the engine assembly 16, connecting the primary structure 24 and the front and/or central part 22.1, 22.2 of the engine core 22.

In a second embodiment that can be seen in FIG. 3 the engine-attachment system 28 includes a front attachment 28.1 connecting the front end 24.1 of the primary structure 24 and the fan fairing 20.1 of the fan 20, a rear attachment 28.2 connecting the rear end 24.3 and/or the median part 24.2 of the primary structure 24 and the rear part 22.3 of the engine core 22, and two links 28.3 positioned symmetrically with respect to the median vertical plane of the engine assembly 16, connecting the primary structure 24 and the front and/or central part 22.1, 22.2 of the engine core 22.

In either embodiment the engine-attachment system 28 includes for each of the first, second and third attachments 28.1, 28.2, 28.3 at least one anchor point on the engine assembly 16, some of these anchor points being offset in the longitudinal direction on the engine assembly fairing F22.

As depicted in FIGS. 2 and 3 the engine assembly fairing F22 supports numerous accessories E that increase the weight of the assembly formed by the engine core 40 and the accessories E supported by the engine core 40. This configuration is less than optimal in terms of distribution of masses.

There is known, in particular from patent application U.S. Pat. No. 2,014,366 555 A1, a device that features a propulsion assembly for aircraft in which a chassis fixed to a pylon supports accessories independently of the engine. This chassis consists of hollow tubes that convey a cooling fluid directly to the accessories. However, this solution, although proposing a distinct support structure for the accessories, is not a satisfactory response to the problem of optimizing the distribution of masses as addressed by the present invention.

### SUMMARY OF THE INVENTION

The present invention aims to remedy some or all of the disadvantages of the prior art.

To this end, the invention presents an aircraft propulsion assembly as described in one or more embodiments herein.

Such a solution enables optimization of the distribution of masses by fixing the accessory onto a structure separate from the engine assembly.

The invention also concerns an aircraft as described in one or more embodiments herein including at least one propulsion assembly.

Such an aircraft benefits from an optimized distribution of masses, which reduces the overall mass of the accessories supported directly by the engine assembly.

### BRIEF DESCRIPTION OF THE DRAWINGS

Other features and advantages will emerge from the following description of the invention given by way of example only with reference to the appended drawings, in which:

FIG. 1 is a perspective view of an aircraft;

FIG. 2 is a schematic lateral representation of an aircraft propulsion assembly (without the nacelle) depicting a first embodiment of the prior art;

FIG. 3 is a schematic lateral representation of an aircraft propulsion assembly (without the nacelle) depicting a second embodiment of the prior art;

FIG. 4 is a schematic lateral representation of an aircraft propulsion assembly (without the nacelle) depicting one embodiment of the invention;

FIG. 5 is a schematic cross section of an aircraft propulsion assembly depicting one embodiment of the invention;

FIG. 6 is a schematic cross section of an aircraft propulsion assembly depicting another embodiment of the invention;

FIG. 7 is a schematic lateral representation of an aircraft propulsion assembly (without the nacelle) depicting one embodiment of the invention;

FIG. 8 is a schematic representation in perspective as seen from the rear of the propulsion assembly (without the nacelle) that can be seen in FIG. 7;

FIG. 9 is a front view of a rear attachment depicting one embodiment of the invention;

FIG. 10 is a schematic lateral representation of an aircraft propulsion assembly including a lattice supporting structure depicting one embodiment of the invention, and,

FIG. 11 is a schematic lateral representation of an aircraft propulsion assembly including a lattice supporting structure depicting another embodiment of the invention.

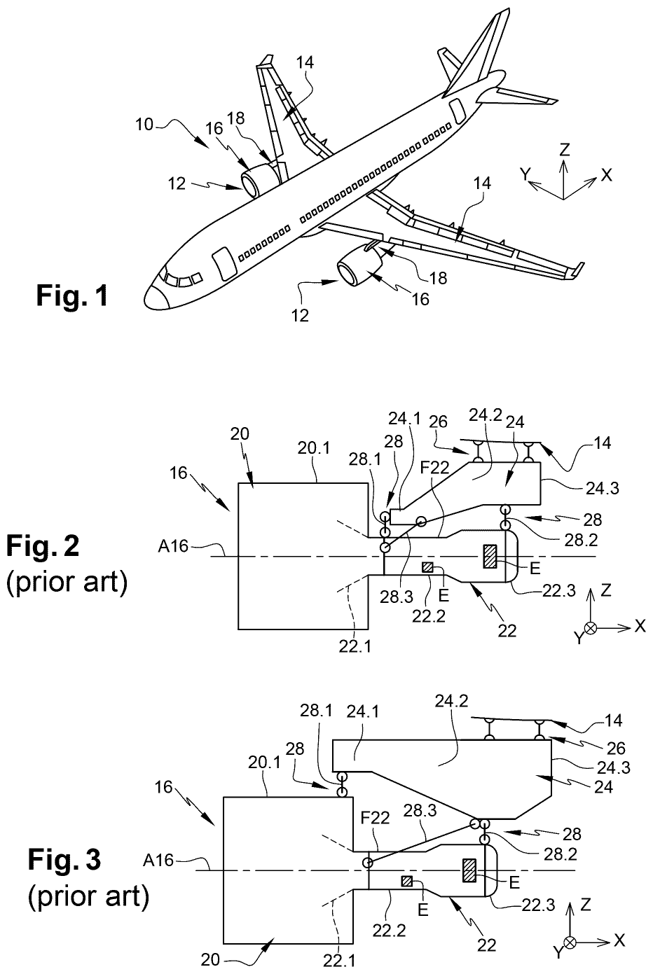

### DETAILED DESCRIPTION OF THE PREFERRED EMBODIMENTS

In an embodiment that can be seen in FIGS. 3 to 8, 10 and 11 a propulsion assembly 30 includes an engine assembly 32 having a rotation axis A32, a nacelle 33 (that can be seen in FIGS. 5 and 6) positioned around the engine assembly 32 and a pylon 34 configured to connect the propulsion assembly 30 and more particularly the engine assembly 32 to the wings 36 of an aircraft. The latter includes at least one such propulsion assembly 30.

In one configuration the engine assembly 32 includes a fan 38 and an engine core 40.

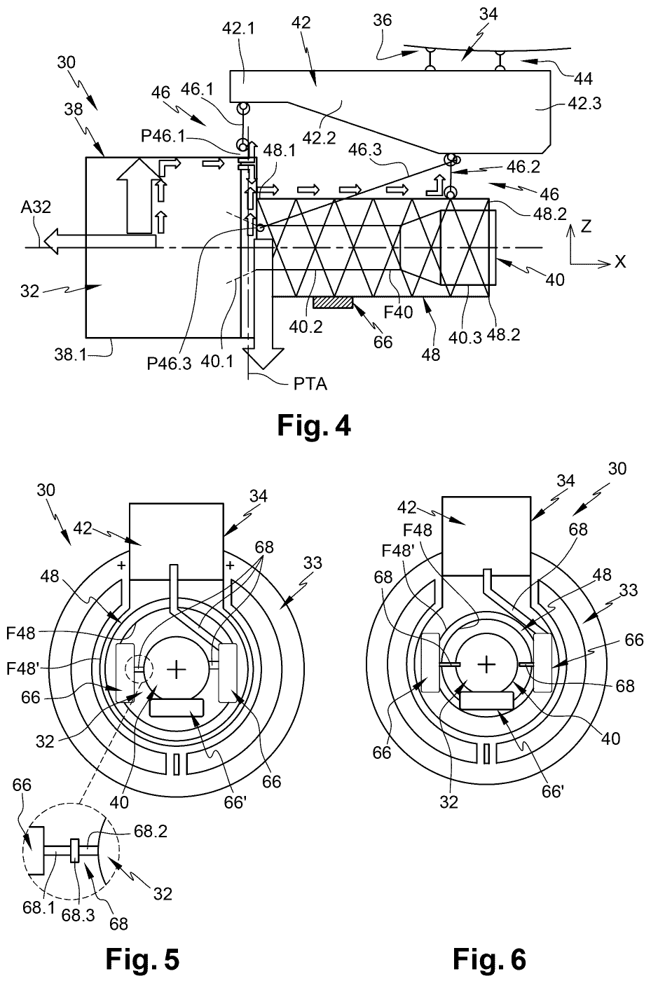

The fan 38 includes a fan fairing 38.1. The engine core 40 includes from the front to the rear a front part 40.1 positioned inside the fan 38, a central part 40.2 and a rear part 40.3 incorporating in particular high-pressure and low-pressure turbines and a jet pipe. In one configuration the central part 40.2 has a cross section less than those of the front and rear parts 40.1, 40.3. The engine core 40 has an exterior envelope called the engine assembly fairing F40 seen in particular in FIG. 4.

The pylon 34 includes a primary structure 42 in the form of a box that is connected to the wings 36 by a wing-attachment system 44 and to the engine assembly 32 by an engine-attachment system 46. This primary structure 42 has a front end 42.1, a median part 42.2 and a rear end 42.3.

The engine-attachment system 46 includes at least one front attachment 46.1 directly connecting the primary structure 42 of the pylon and the engine assembly 32 (the fan 38 and/or the front part 40.1 of the engine core 40). In a preferred embodiment the front attachment 46.1 connects the fan fairing 38.1 of the fan 38 and the front end 42.1 of the primary structure 42. This front attachment 46.1 is configured to absorb thrust forces. In one configuration, the front attachment 46.1 is identical to that of the prior art. In accordance with one particular feature of the invention the propulsion assembly 30 includes at least one supporting structure 48 that extends between front and rear ends 48.1, 48.2 oriented along an axis parallel to the longitudinal direction between the nacelle and the engine core 40, the front end 48.1 being connected to the engine assembly 32. In a preferred embodiment the supporting structure 48, to be more specific its front end 48.1, is connected to the fan 38 and more particularly to the fan fairing 38.1.

The engine-attachment system 46 includes at least one rear attachment 46.2 offset toward the rear relative to the front attachment 46.1 and connecting the primary structure 42 and the supporting structure 48. In one arrangement the rear attachment 46.2 connects the median part 42.2 and/or the rear end 42.3 of the primary structure 42 and the rear end 48.2 of the supporting structure 48 or a zone in the vicinity of that rear end 48.2.

In one embodiment the engine-attachment system 46 includes two links 46.3, positioned symmetrically with respect to a median vertical plane PMV of the engine assembly 32 and connecting the primary structure 42 and the front and/or central part 40.1, 40.2 of the engine core 40.

In one arrangement the front attachment 46.1 and the links 46.3 are connected to the engine assembly 32 at anchor points P46.1, P46.3 positioned in approximately (+/−10%) the same transverse attachment plane PTA. In one embodiment the engine-attachment system 46 includes at least one front attachment 46.1 directly connecting the engine assembly 32 and the primary structure 42, said front attachment 46.1 being connected to the engine assembly 32 at the level of a transverse attachment plane PTA.

The supporting structure 48 is also connected to the engine assembly 32 approximately at the level of the transverse attachment plane PTA. The supporting structure 48 is, over at least a part of the circumference of the engine assembly 32 and preferably all said circumference, spaced from the engine core 40 and positioned between the engine core 40 and the nacelle 33.

In one embodiment the supporting structure 48 is a beam that does not extend around the engine core 40. In another embodiment the supporting structure 48 extends over at least a part of the circumference of the engine core 40.

The supporting structure 48 is tubular and extends all around the engine core 40. In this embodiment, as depicted in FIGS. 5 and 6, the supporting structure 48 includes an interior face F48 oriented toward the engine core 40 and an exterior face F48′ oriented toward the nacelle 33.

In a first embodiment that can be seen in FIG. 4 the supporting structure 48 is cylindrical.

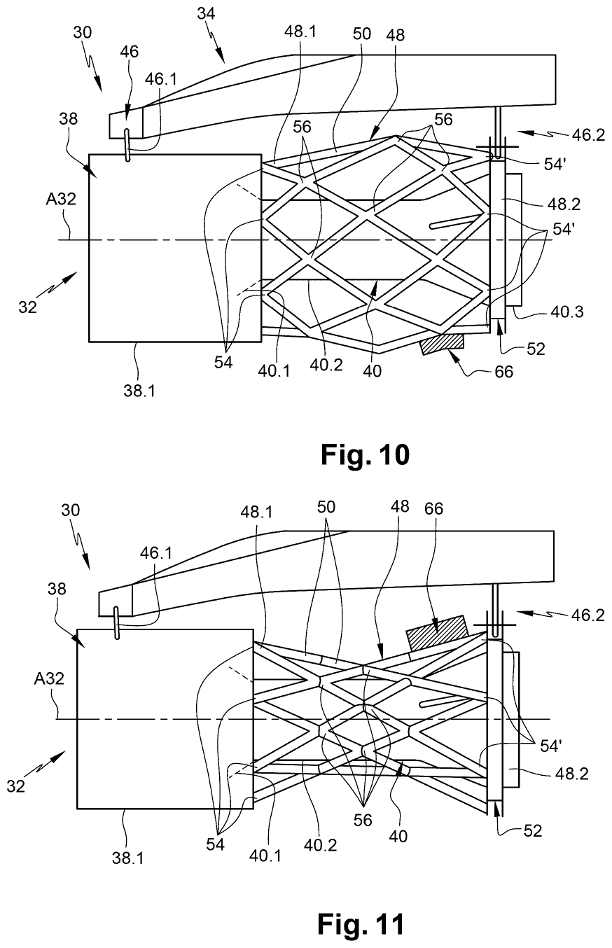

In another embodiment that can be seen in FIG. 10 the supporting structure 48 is barrel-shaped.

In another embodiment that can be seen in FIG. 11 the supporting structure 48 has a hyperbolic shape.

Of course the invention is not limited to these geometries of the supporting structure 48.

In a configuration that can be seen in FIG. 5 the supporting structure 48 is closer to the nacelle 33 than the engine core 40 in at least one transverse plane.

In another configuration that can be seen in FIG. 6 the supporting structure 48 is closer to the engine core 40 than the nacelle 33 in at least one transverse plane.

In an embodiment that can be seen in particular in FIGS. 10 and 11 the supporting structure 48 is an openwork structure separate from the primary structure 42 of the pylon and from the exterior envelope F40 of the engine core 40. This openwork structure has an open factor (corresponding to the ratio of the sum of the open areas to the total area) of at least 50%.

Furthermore, in contrast to the exterior envelope F40 of the engine core 40, it has sufficient rigidity to form a path for forces between the engine assembly 32 and the primary structure 42. In one configuration the openwork structure is a lattice structure that includes a plurality of lengthwise reinforcements 50 and at least one transverse reinforcement 52. The lattice supporting structure 48 can include at least one longitudinal reinforcement that extends from its front end 48.1 to its rear end 48.2.

In one configuration each lengthwise reinforcement 50 is rectilinear and has a circular section. Of course the invention is not limited to this section of the lengthwise reinforcements 50.

Some lengthwise reinforcements 50 are directly connected to the engine assembly 32, in each case by a connecting system 54 including for example at least one element such as a pin, a rivet, a bolt or any other connecting element.

Some lengthwise reinforcements 50 are directly connected to a transverse reinforcement 52, in each case by a connecting system 54′ including for example at least one element such as a pin, a rivet, a bolt or any other connecting element.

In one embodiment that can be seen for example in FIGS. 10 and 11 the lattice supporting structure 48 includes a single rear transverse reinforcement 52 at its rear end 48.2.

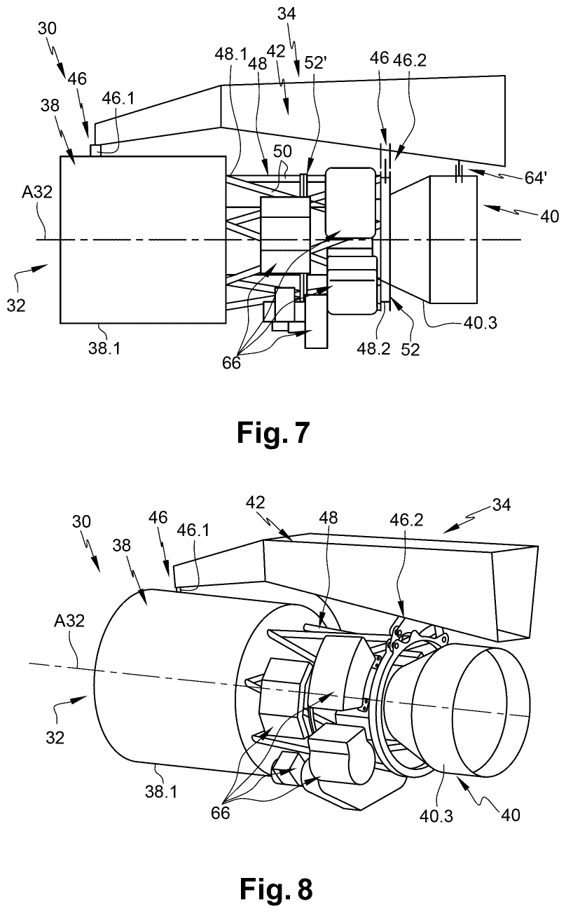

In another embodiment that can be seen in FIG. 7 the lattice supporting structure 48 includes a rear transverse reinforcement 52 at the rear end 48.2 and at least one intermediate transverse reinforcement 52′ between the front and rear ends 48.1, 48.2 of the lattice supporting structure 48.

The lattice supporting structure 48 could include a front transverse reinforcement at the front end 48.1 of the lattice supporting structure 48 and directly connected to the engine assembly.

In embodiments that can be seen in FIGS. 10 and 11 the lengthwise reinforcements 50 are interconnected at the level of nodes 56 in such a manner as to form quadrilateral or triangular meshes.

In these embodiments the lengthwise reinforcements 50 connected to the transverse reinforcement 52 or to the engine assembly 32 form with the latter triangular meshes.

In another embodiment that can be seen in FIG. 7 the lengthwise reinforcements 50, the transverse reinforcements 52, 52′ and the engine assembly 32 are interconnected in such a manner as to form triangular meshes.

Of course the invention is not limited to these geometries of the meshes. The lattice openwork longitudinal structure 48 generally includes lengthwise reinforcements 50 and/or at least one transverse reinforcement 52 interconnected in such a manner as to form quadrilateral or triangular meshes in order to obtain an openwork structure.

The longitudinal and transverse reinforcements 50, 52, 52′ can be made of metal and/or composite material.

In one embodiment at least one transverse reinforcement 52, 52′ includes at least one plate positioned in a transverse plane. In one arrangement at least one transverse reinforcement 52 includes two closely spaced and interconnected parallel plates.

In one configuration at least one transverse reinforcement 52, 52′ extends continuously over all the circumference of the engine core 40 and forms a ring. In another configuration at least one transverse reinforcement 52, 52′ forms a U shape that has ends oriented toward the primary structure 42.

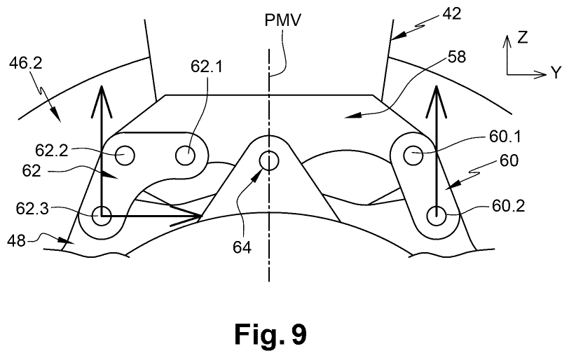

In an embodiment details of which can be seen in FIG. 9 the rear attachment 46.2 connecting the supporting structure 48 and the primary structure 42 is configured to absorb forces in horizontal and vertical transverse directions Y, Z and torque around the rotation axis A32 of the engine assembly 32. It includes:
a transverse beam 58 rigidly attached to the primary structure 42,
at least one first, two-point link 60 positioned on a first side of the median vertical plane PMV and connected to the transverse beam 58 by a first pivot pin 60.1 and to the supporting structure 48 by a second pivot pin 60.2,
at least one second, three-point link 62 positioned on a second side of the median vertical plane PMV and connected to the transverse beam 58 by third and fourth pivot pins 62.1, 62.2 and to the supporting structure 48 by a fifth pivot pin 62.3.

The various pivot pins 60.1, 60.2, 62.1, 62.2, 62.3 are substantially parallel to one another and to the longitudinal direction X.

In this embodiment the first, two-point link 60 is configured to transfer forces along a substantially vertical axis. Complementing this, the second, three-point link 62 is configured to transfer forces in the horizontal and vertical directions Y, Z. The first and second links 60, 62 enable absorption of torsion forces in the longitudinal direction X.

In one embodiment the engine-attachment system 46 includes at least one fail-safe type safety connection 64, 64′ connecting the primary structure 42 and the support structure 48 or the engine assembly 32, in particular the engine core 40, configured so as not to form a path for forces when the rear attachment 46.2 is operational and functioning correctly and to form a path for forces in the event of the rear attachment 46.2 being damaged.

In an arrangement that can be seen in FIG. 9 the fail-safe type safety connection 64 connects the transverse beam 58 and the supporting structure 48, in particular the rear end 48.2 of the connecting structure 48.

The propulsion assembly 30 includes at least one accessory 66 necessary for the correct functioning of the engine assembly 32. The accessory 66 is one from a non-exhaustive list of accessories including exchangers, pumps, sensors and electrical or hydraulic regulation devices, etc.

The propulsion assembly 30 includes for at least one accessory 66, depending on its kind, at least one connection 68 for transferring mechanical, electrical or fluidic energy between the accessory 66 and the engine assembly 32 and/or to an element positioned in the pylon 34, the wings 36 or the fuselage of the aircraft. In one configuration, the energy and/or information connections 68 includes first and second sections 68.1, 68.2 respectively connected to the accessory 66 and to the engine assembly 32 and at least one connector assembly 68.3 configured to connect and to disconnect the first and second sections 68.1, 68.2.

In accordance with one particular feature of the invention at least one accessory 66 is connected to the supporting structure 48 in the space between the nacelle 33 and the engine core 40.

In an arrangement that be seen in FIGS. 5 and 6 the accessory 66 is positioned against the interior face F48. In another arrangement that can be seen in FIG. 6 the accessory 66 is positioned against the exterior face F48′.

In one embodiment the propulsion assembly 30 includes a plurality of accessories 66 connected to the supporting structure 48 and positioned on the interior face F48 and/or on the exterior face F48′.

In a configuration that be seen in FIGS. 5 and 6 at least one accessory 66′ that cannot be separated from the engine core 40 is fixed to the latter. In accordance with the invention a maximum number of accessories 66 are connected to the supporting structure 48 in order to reduce the number of accessories 66′ supported by engine core 40.

This solution enables optimization of the distribution of masses by reducing the mass of the accessories 66 supported by the engine assembly 32.

In any embodiment the supporting structure 48 (whether solid, openwork or lattice) enables transfer of loads between the engine assembly 32 and the primary structure 42 of the pylon, the forces being absorbed at the level of the same part of the engine assembly 32, namely the fan fairing 38.1.

The fact that the supporting structure 48 is a lattice structure enables an openwork structure to be obtained that facilitates access to the engine core 40, in particular for maintenance or repair operations. Finally, providing a lattice structure enables reduction of the mass and obtaining a rigid structure that has a high stiffness in all directions.

Of course, the invention is not limited to engine assemblies that include a fan positioned in a fan fairing. Thus it can apply to any engine assembly that extends from front to rear in a longitudinal direction and includes a front part and a rear part connected to the front part and offset toward the rear in the longitudinal direction relative to the front part. The rear part can be a part of the engine core of a turbojet or a turboprop engine. Depending on the application, the front part can be a fan fairing 38.1 in the case of a ducted fan. The front part can also be a supporting structure on which is mounted a fan or an unshrouded propeller or any other structure of an engine assembly 32 positioned at the front of the latter and configured to form a path for thrust forces generated during use of the engine assembly 32. Each of the front and rear parts has a circumferential shape and the front part of the engine assembly 32 has a section greater than that of the rear part.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An aircraft propulsion assembly comprising:
an engine assembly extending from a front to a rear along a longitudinal axis and including, at the front, a front part and, at the rear of the front part, a rear part, the front part and the rear part each having a circumferential shape, the front part having a section greater than a section of the rear part;
a nacelle positioned around the engine assembly;
a primary structure of a pylon;
at least one accessory;
an engine-attachment system connecting the primary structure and the engine assembly that includes at least one front attachment directly connecting the front part of the engine assembly and the primary structure;
at least one tubular supporting structure extending along an axis parallel to the longitudinal axis between the nacelle and the rear part of the engine assembly, all around the rear part of the engine assembly, the at least one tubular supporting structure connected to the front part of the engine assembly,
wherein the engine-attachment system comprises at least one rear attachment offset toward the rear relative to the at least one front attachment and connecting the primary structure and the at least one tubular supporting structure, and
wherein at least one accessory is connected to the at least one tubular supporting structure.

2. The aircraft propulsion assembly according to claim 1, further comprising:
at least one connection for transferring mechanical energy, electrical energy, or fluidic energy between said at least one accessory and the engine assembly and including a first section and a second section respectively connected to said at least one accessory and to the engine assembly as well as at least one connector assembly configured to connect and disconnect the first section and the second section.

3. The aircraft propulsion assembly according to claim 1, wherein the front attachment and the at least one tubular supporting structure are connected to the engine assembly approximately at a level of a same transverse attachment plane.

4. The aircraft propulsion assembly according to claim 1, wherein the at least one tubular supporting structure is a lattice structure and includes lengthwise reinforcements comprising meshes.

5. The aircraft propulsion assembly according to claim 4, wherein the at least one tubular supporting structure extends between a front end and a rear end, the front end connected to the engine assembly, and
wherein the lattice structure includes at least one transverse reinforcement at the rear end.

6. The aircraft propulsion assembly according to claim 5, wherein the at least one transverse reinforcement extends over all of a circumference of the rear part of the engine assembly to form a ring.

7. The aircraft propulsion assembly according to claim 1, wherein the at least one rear attachment includes:
a transverse beam rigidly attached to the primary structure,
at least one first, two-point link on a first side of a median vertical plane connected to the transverse beam by a first pivot pin and to the at least one tubular supporting structure by a second pivot pin, and,
at least one second, three-point link on a second side of the median vertical plane and connected to the transverse beam by third and fourth pivot pins and to the at least one tubular supporting structure by a fifth pivot pin.

8. The aircraft propulsion assembly according to claim 1, wherein the engine-attachment system includes at least one fail-safe safety connection connecting the primary structure and the at least one tubular supporting structure or the rear part of the engine assembly, and
wherein the at least one fail-safe safety connection is configured so as not to form a path for forces when the rear attachment is operational and to form a path for forces in an event of the rear attachment is damaged.

9. The aircraft propulsion assembly according to claim 1, wherein the front part and the rear part of the engine assembly are respectively a fan fairing of a ducted fan and an engine core.

10. The aircraft propulsion assembly according to claim 1, wherein the front part and the rear part of the engine assembly are respectively a supporting structure, on which is mounted a fan or an unducted propeller, and an engine core.

11. An aircraft comprising:
at least one aircraft propulsion assembly according to claim 1.
